(19) United States
(12) Patent Application Publication
(10) Pub. No.: US 2014/0077609 A1
(43) Pub. Date: Mar. 20, 2014

(54) SERIALLY CONNECTED MICRO-INVERTER SYSTEM WITH TRUNK AND DROP CABLING

(71) Applicant: Enphase Energy, Inc., Petaluma, CA (US)

(72) Inventor: Martin Fornage, Petaluma, CA (US)

(73) Assignee: Enphase Energy, Inc., Petaluma, CA (US)

(21) Appl. No.: 14/031,763

(22) Filed: Sep. 19, 2013

Related U.S. Application Data
(60) Provisional application No. 61/703,017, filed on Sep. 19, 2012.

(51) Int. Cl. H01R 4/00; H02M 7/42

(52) U.S. Cl. CPC H01R 4/00; H02M 7/42
USPC 307/77; 174/84 R

(57) ABSTRACT

A system and apparatus for serially coupling a plurality of inverters. In one embodiment, the apparatus comprises a cable assembly for (i) coupling the plurality of inverters in series to form a string, and (ii) coupling AC power generated by the plurality of inverters to the AC grid, wherein the cable assembly comprises (A) a trunk cable comprising at least one phase conductor and a neutral conductor, wherein the neutral conductor is conductively continuous throughout the trunk cable; and (B) a plurality of junction boxes, positioned at locations along the trunk cable, for coupling the plurality of inverters to the trunk cable, wherein at each junction box of the plurality of junction boxes the at least one phase conductor is discontinuous for being coupled to a corresponding inverter of the plurality of inverters.

### CROSS-REFERENCE TO RELATED APPLICATIONS

This application claims benefit of U.S. provisional patent application Ser. No. 61/703,017, filed Sep. 19, 2012, which is herein incorporated in its entirety by reference.

### BACKGROUND

1. Field

Embodiments of the present invention generally relate to distributed power systems and, more particularly, to a serially connected micro-inverter system with trunk and drop cabling.

2. Description of the Related Art

Distributed power systems typically comprise a power source that generates direct current (DC) power, a power converter, and a controller. The power source may be a solar panel or solar panel array, a wind turbine or a wind turbine array, a hydroelectric generator, fuel cell, and the like. The power converter converts the DC power into alternating current (AC) power, which may be coupled directly to the AC power grid. The controller monitors and controls the power sources and/or power converter to ensure that the power conversion process operates as efficiently as possible.

One type of power converter is known as a micro-inverter. Micro-inverters typically convert DC power to AC power at the power source. Thus, each power source is typically coupled to a single micro-inverter. A plurality of AC power outputs from the micro-inverters are coupled in parallel to the AC power grid. Since the outputs of each micro-inverter are coupled in parallel directly to the AC power grid, all the parallel connected micro-inverters are simply synchronized to the AC voltage of the AC power grid.

Because of the parallel connected nature of a parallel connected micro-inverter system, the output voltage of each micro-inverter is substantial, e.g., hundreds of volts. Consequently, the micro-inverters are typically buck-boost type inverters with an H-bridge output circuit that require a transformer to generate the high-voltage and switching transistors to handle the high-voltage within the H-bridge to produce the AC wave form. The transformer and high-voltage transistors add significant cost to the manufacturing cost of a micro-inverter.

Therefore, there is a need in the art for a distributed power system that does not require transformers and high-voltage transistors.

### SUMMARY OF THE INVENTION

Embodiments of the present invention generally relate to an apparatus and a system for serially coupling a plurality of inverters substantially as shown in and/or described in connection with at least one of the figures, as set forth more completely in the claims.

Various advantages, aspects and novel features of the present disclosure, as well as details of an illustrated embodiment thereof, will be more fully understood from the following description and drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a serially connected micro-inverter (SCMI) system in accordance with various embodiments of the invention;

FIG. 2 illustrates the power combination that occurs within the SCMI system of FIG. 1;

FIG. 3 is a block diagram of an embodiment of an SCMI that can be used within the SCMI system of FIG. 1;

FIG. 4 depicts a schematic diagram of a voltage source inverter (VSI) that can be used within the SCMI system of FIG. 1;

FIG. 5 depicts a schematic diagram of a current source inverter (CSI) that can be used within the SCMI system of FIG. 1;

FIG. 6 depicts a block diagram of an embodiment of a controller that can be used within the SCMI system of FIG. 1;

FIG. 7 depicts a block diagram of an embodiment of trunk and drop cabling for serially interconnecting the micro-inverters and coupling power to an AC grid in accordance with at least one embodiment of the invention;

FIG. 8 depicts a schematic diagram of one embodiment of a junction block of the trunk and drop cable of FIG. 7;

FIG. 9 depicts a schematic view of a cap used to terminate unused drops in the trunk and drop cabling system in accordance with one embodiment of the invention; and

FIG. 10 is a schematic view of an end cap for terminating a trunk cable in accordance with one embodiment of the invention.

### DETAILED DESCRIPTION

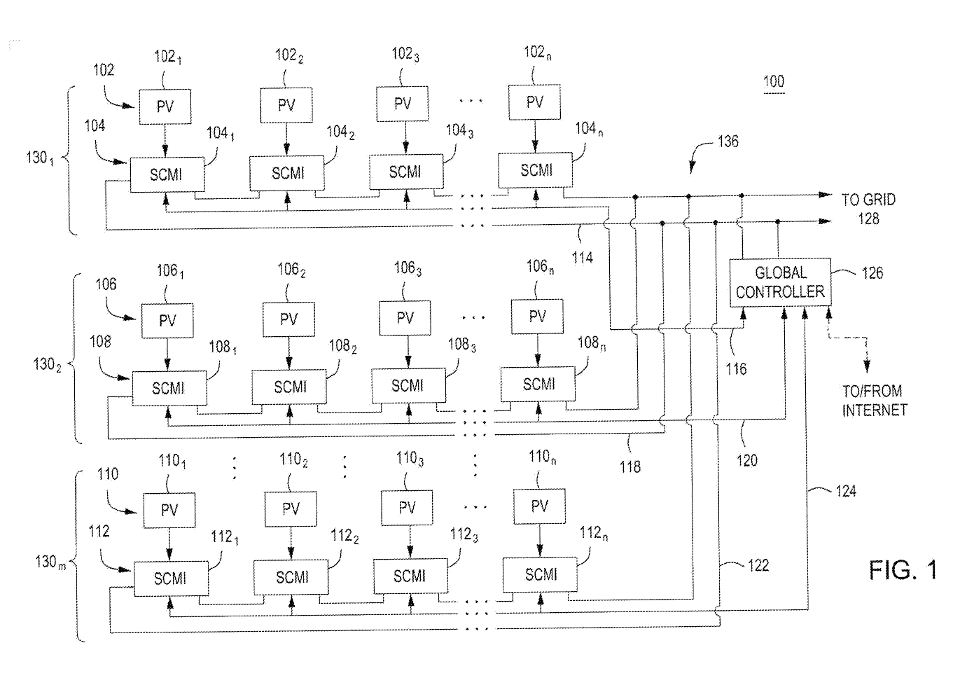

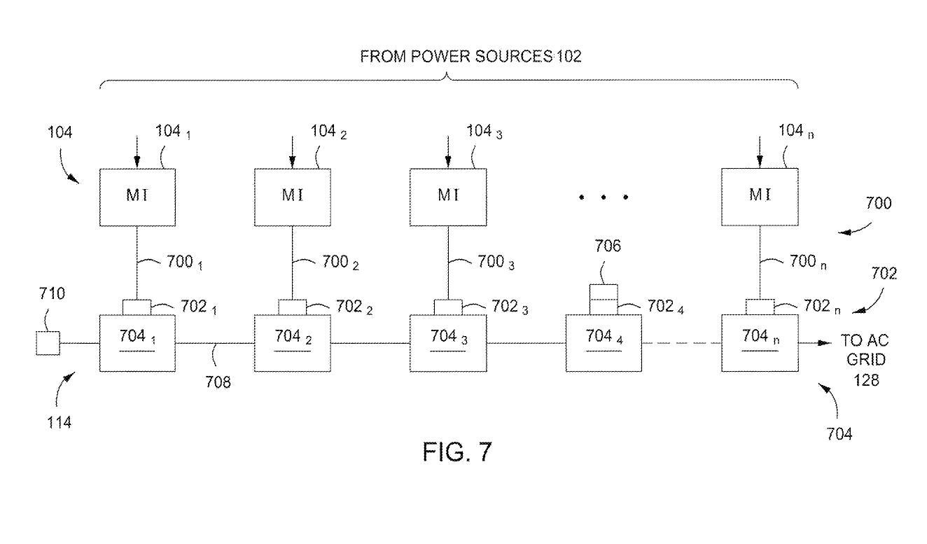

FIG. 1 depicts a block diagram of a serially connected micro-inverter (SCMI) system 100 in accordance with various embodiments of the invention. The system 100 comprises a plurality of power sources (e.g., photovoltaic (PV) modules) 102₁, 102₂, 102₃, . . . , 102ₙ (collectively referred to as 102), a plurality of SCMI 104₁, 104₂, 104₃, . . . , 104ₙ (collectively referred to as 104), and a global controller 126. Each power source 102 is coupled to an associated SCMI 104 (which also may be referred to as a micro-inverter 104 or an inverter 104) and a plurality of the SCMIs 104 are coupled in series with one another via an AC bus 114 to form a “string” 130₁. One embodiment of the AC bus 114 is a trunk and drop cabling system described in detail with respect to FIGS. 7, 8 and 9. A plurality of strings 130₁, 130₂, . . . , 130ₘ may be coupled in parallel to form an array of strings. String 130₂ comprises power sources 106, SCMI 108 and an AC bus 118, while string 130ₘ comprises power sources 110, SCMI 112, and an AC bus 122, where the power sources 106 and 110 are analogous to the power sources 102, the SCMIs 108 and 112 are analogous to the SCMI 104, and the AC buses 118 and 122 are analogous to the AC bus 114. The voltage at the end of each string 130 is generally equal to the AC grid voltage.

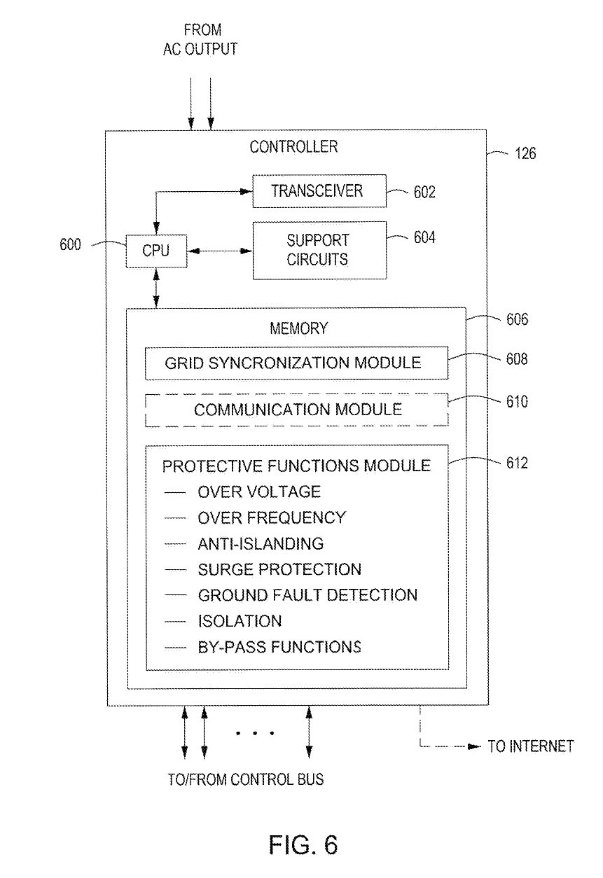

The global controller 126 is coupled to a location on the AC buses 114, 118, 122 where the buses are coupled together and are further coupled to an AC power grid 128. From this coupling junction 136, the global controller 126 samples the output voltage and the output current. The global controller 126 is coupled to a plurality of control buses 116, 120 and 124. These control buses couple control signals from the controller 126 to each of the SCMI 104, 108 and 112. Consequently, the global controller 126 controls many aspects and functions of the SCMI as shall be described in detail with reference to FIG. 6 below.

Although FIG. 1 depicts photovoltaic modules as the power sources, other power sources, e.g., wind turbines, a hydroelectric generators, fuel cells, and the like may also be utilized. Furthermore, the depicted embodiment shows three strings 130, each comprising four SCMI. The variables n and m represent that any number of SCMIs and strings may be used to form an n by m array of power generators (PV modules and SCMI combinations). The variable n is defined by the AC grid voltage divided by the maximum output voltage of the micro-inverters. The variable m is unlimited.

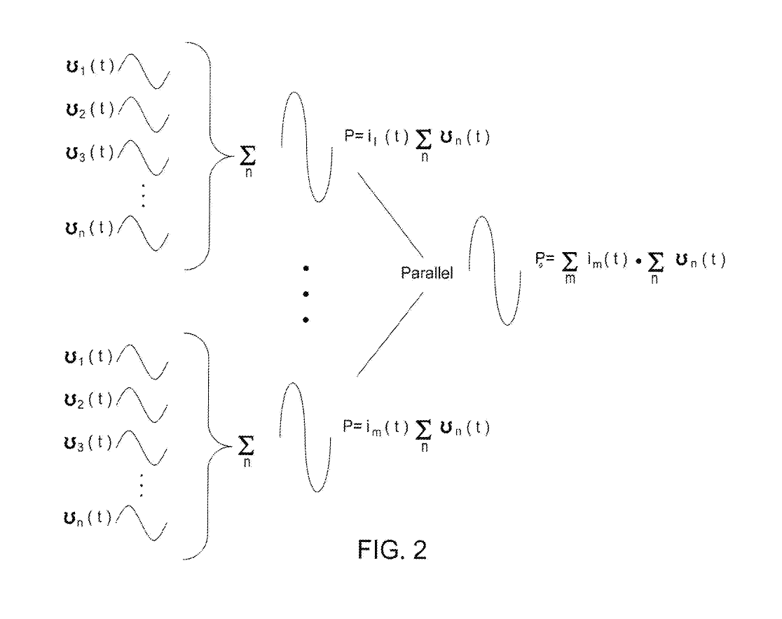

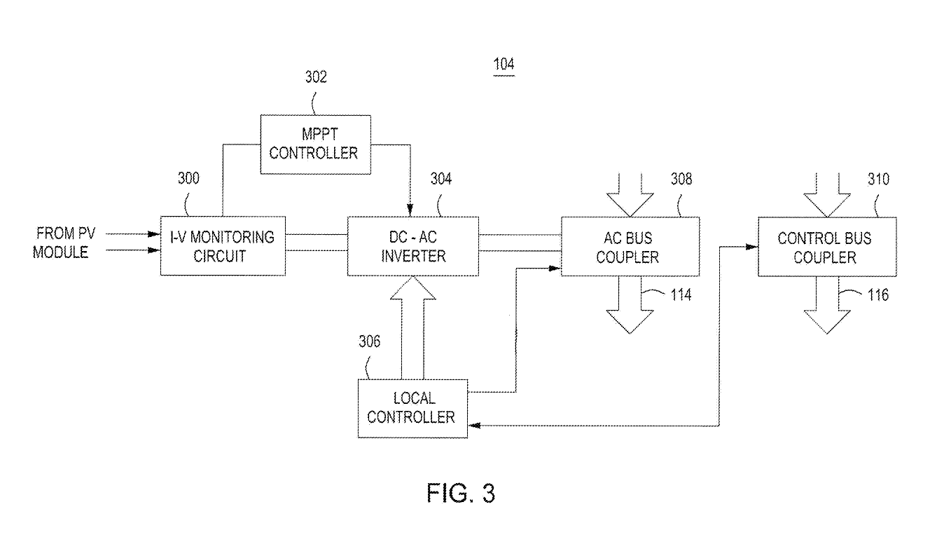

FIG. 2 illustrates the power combination that occurs in the SCMI system 100 of FIG. 1. Each SCMI generates vₙ(t) and i(t) on the AC bus—the voltage waveforms are shown for a single cycle of AC power generated by an SCMI. Because the SCMIs are serially connected, the current through each SCMI within a given string 130 is the same, although the current value of the string 130 may vary over time with environmental conditions. The voltage vₙ(t) produced by each SCMI varies with the illumination intensity incident upon the PV module, i.e., more sunlight produces a higher output voltage. To produce a maximum power output for a given sunlight irradiance, the SCMIs generally utilize a maximum power point tracking (MPPT) technique as shall be discussed with reference to FIG. 3 below.

The serial connection of the SCMIs results in a summation of the voltage (and power) produced by each SCMI within a string 130. As such, the power generated by a string 130 is represented by:

$$P ( t ) = {i}_{m} ( t ) \cdot {\sum }_{n} {v}_{n} ( t )$$

where:

P(t) is the power generated by a given string 130;

iₘ(t) is the current in a given string 130; and

vₙ(t) is the voltage produced by each SCMI.

Thus, for a string 130 of SCMIs, the summed voltage equals the desired AC grid voltage, e.g., a 240 volt grid voltage may use twelve 20-volt SCMIs. Each of the strings are connected in parallel to produce an output power represented by:

$$P ( t ) = {\sum }_{m} ( {i}_{m} ( t ) \cdot {\sum }_{n} {v}_{n} ( t ) )$$

where:

P₀(t) is the power generated by the SCMI system;

iₘ(t) is the current in a given string 130; and

vₙ(t) is the voltage produced by each SCMI.

FIG. 3 depicts a block diagram of an SCMI that may be used in the SCMI system 100 of FIG. 1. The SCMI (e.g., SCMI 104) comprises a current-voltage (I-V) monitoring circuit 300, an MPPT controller 302, a DC-AC inverter 304, a local controller 306, an AC bus coupler 308 and a control bus coupler 310.

The I-V monitoring circuit 300 monitors the instantaneous voltage and current output levels, V_{PV} and I_{PV}, respectively, from the PV module 102, and provides a signal indicative of such current and voltage information to the MPPT controller 302. The I-V monitoring circuit couples DC power to the DC-AC inverter 304. The MPPT controller 302 is coupled to the DC-AC inverter 304 and controls the voltage across the corresponding PV module to ensure that the maximum power point is maintained, i.e., the maximum current and voltage for a given irradiance. Various well-known algorithms and techniques are available for use as an MPPT controller.

The DC-AC inverter 304 converts the DC power from the PV module into AC power. The inverter 304 operates at a relatively low voltage, e.g., 20-50 volts DC. An inverter that operates at such a low voltage does not require a transformer or high-voltage transistors. In addition, in one embodiment, a low voltage inverter is fabricated on a single substrate, i.e., forming a single chip inverter. Such a single integrated circuit may include the monitoring circuit 300, MPPT controller 302 and/or local controller 306 as well as some components of the couplers 308 and 310.

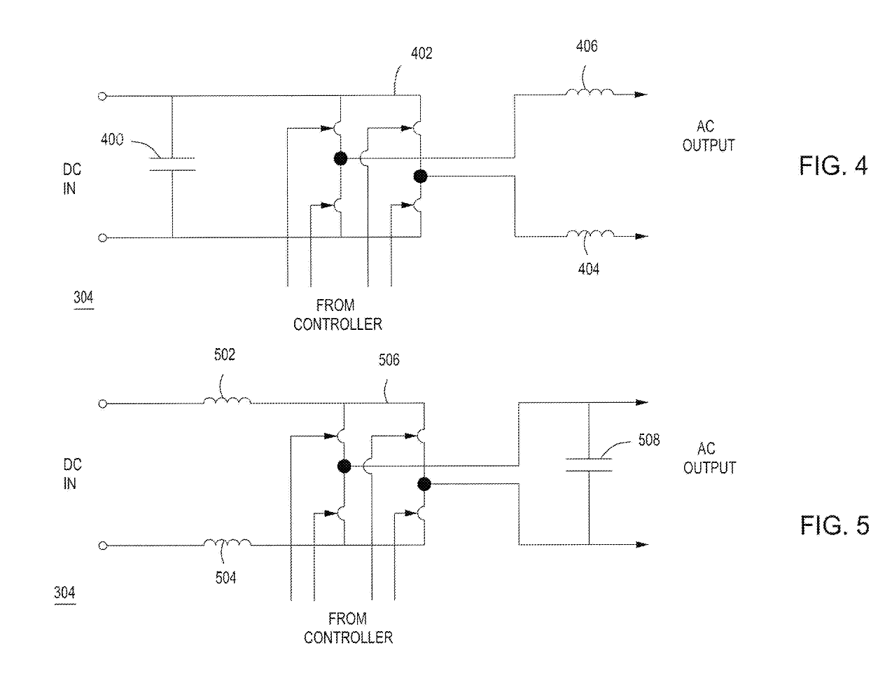

FIGS. 4 and 5 below depict typical schematic configurations for low voltage inverters. The AC output of the DC-AC inverter 304 is coupled to the AC bus coupler 308 that serially couples AC output power to the AC bus 114.

The local controller 306 is coupled to the DC-AC inverter 304 and controls operation of the DC-AC inverter 304. The local controller 306 is coupled to the control bus via control bus coupler 310 and receives control signals from a system controller (controller 126 in FIG. 1). Specifically, the local controller 306 ensures that the AC output of the inverter 304 is in phase with the AC grid voltage. In addition, the local controller 306 can monitor and report operation and functional information to the control bus coupler 310. Also, the local controller 306 provides a bypass control signal to the AC bus coupler 308. The bypass control signal controls a plurality of switches within the AC bus coupler 308 that disconnects the inverter 304 from the AC bus 114 and creates a short circuit on the bus 114. As such, a faulty SCMI can be disconnected from the bus 114 while still allowing the string of remaining SCMIs to operate. Such bypass only occurs if the string has sufficient voltage margin, i.e., can produce the required voltage without losing MPPT.

FIGS. 4 and 5 each depict a schematic diagram of a different type of DC-AC inverter circuit that can be used as inverter 304 in FIG. 3. These inverters are considered exemplary, other types of inverters may be used. FIG. 4 depicts a schematic of a voltage source inverter (VSI) 304 in accordance with one or more embodiments of the present invention. The VSI 304 comprises an input capacitor 400 coupled across the input of an H-bridge 402, and output inductors 404 and 406 coupled to first and second outputs, respectively, of the H-bridge 402. In short, the applied DC voltage is pulsed from the input to the output using the H-bridge 402 to create positive and negative pulses synchronized with the AC grid voltage. FIG. 5 depicts a schematic of a current source inverter (CSI) 304 in accordance with one or more embodiments of the present invention. The CSI 304 comprises inductors 502 and 504 coupled to first and second inputs, respectively, of an H-bridge 506, and a capacitor 508 coupled across the output of the H-bridge 506. The CSI 304 is the dual of a VSI and operates in a similar manner to produce an AC waveform from a DC input.

FIG. 6 depicts a block diagram of an embodiment of the controller 126 of FIG. 1. The controller 126 comprises a central processing unit (CPU) 600 coupled to each of a transceiver 602, support circuits 604, and memory 606. The CPU 600 may be any commercially available processor, microprocessor, microcontroller, and the like. The transceiver 602 communicates with the SCMI via wired (e.g., power line communications (PLC)) or wireless communications. In one embodiment, the communications channel is formed via the control bus. In other embodiments, the communications channel may be formed via WiFi (e.g., 802.11 standard communications techniques) or other wireless techniques. The support circuits 604 comprise well known circuits that provide functionality to the CPU 600 such as clock circuits, cache, power supplies, I/O circuits, and the like.

The memory 606 may be any form of digital storage used for storing data and executable software. Such memory includes, but is not limited to, random access memory, read only memory, disk storage, optical storage, and the like. The memory 606 stores a grid synchronization module 608, a communications module 610, and a protective functions module 612. Additionally, the memory 606 may store one or more databases for storing data, for example, related to the present invention.

The grid synchronization module 608 digitizes the voltage at the AC output and generates synchronization signals for the SCMIs. The grid synchronization module 608 addresses the synchronization signals to each individual SCMI, where the local controller (306 in FIG. 3) produces the appropriate switching signals for the H-bridge to generate an AC waveform that is approximately synchronized with the AC grid voltage.

In other embodiments, the grid synchronization module 608 may send a sample of the AC grid voltage or couple the actual voltage to the SCMI to be used locally for synchronization, i.e., send a reference phase to the SCMIs. In other embodiments, the grid synchronization module 608 may not be used and the synchronization may be performed locally.

The communications module 610 generates the appropriate data structures and signaling for the channel to be used in communicating with the SCMIs. In some embodiments, the communications module 610 formats data for communication via the Internet to a remote monitoring station. The information may be communicated from the SCMIs regarding SCMI functionality, efficiency, up time, irradiance of the associated PV module, and so on.

In one embodiment, the protective functions module 612 monitors the voltage magnitude at the AC output. In other embodiments the protective functions module 612 may additionally monitor the signals on each string 130. In some embodiments, the module 612 may disconnect the SCMI system from the grid to isolate the system for repairs or diagnostics. In other embodiments, the module 612 is configured to deactivate the SCMI system upon identifying a fault that may harm the grid or harm the SCMI system. Such “global” faults include over voltage or over frequency conditions with respect to the grid, a grid power outage, a surge on the grid, a ground fault and the like. For each of these situations, the entire SCMI system is deactivated and disconnected from the grid to isolate the SCMI system from the grid. Such action provides anti-islanding protection for grid workers during a grid power outage.

In addition, the module 612 may detect a fault (a “local” fault) in a particular SCMI (via data sent from the SCMIs). Upon detection of a local fault, the module 612 sends a signal to the SCMI local controller 306 to bypass the faulty SCMI. The module 612 also monitors the number of bypassed SCMIs on each string 130 to ensure that not too many are bypassed. If too many SCMI are being bypassed, the remaining functional units must make up the lack of voltage not being produced by the bypassed SCMIs. This can lead to an inability to maintain MPPT and, ultimately, additional SCMI failures through operating the SCMIs at dangerous power levels.

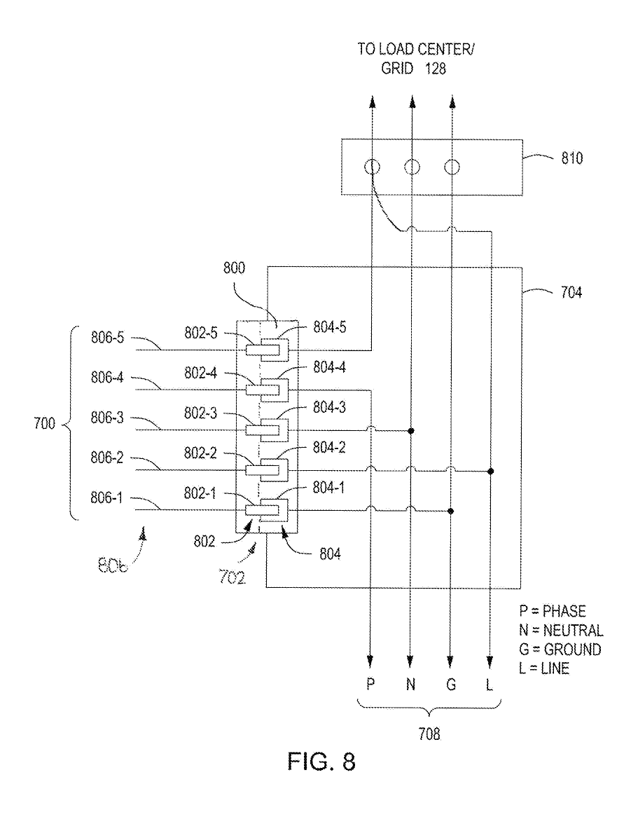

FIG. 7 depicts a block diagram of one embodiment of the AC bus 114 for serially interconnecting the micro-inverters 104 in accordance with one or more embodiments of the present invention. The AC bus 114 (a trunk and drop cabling system) comprises a trunk cable 708, a plurality of junction boxes 704₁, 704₂, 704₃, . . . , 704ₙ (collectively referred to as junction boxes 704), a plurality of drop cables 700₁, 700₂, 700₃, . . . , 700ₙ (collectively referred to as drop cables 700), and, in some embodiments, a plurality of connectors 702₁, 702₂, 702₃, . . . , 702ₙ (collectively referred to as connectors 702). The drop cables 700₁, 700₂, 700₃, . . . , 700ₙ are coupled in a one-to-one correspondence to SCMIs 104₁, 104₂, 104₃, . . . , 104ₙ, and are further coupled in a one-to-one correspondence to junction boxes 704₁, 704₂, 704₃, . . . , 704ₙ. In some embodiments, the drop cables 700₁, 700₂, 700₃, . . . , 700ₙ may be coupled to the junction boxes 704₁, 704₂, 704₃, . . . , 704ₙ via corresponding connectors 702₁, 702₂, 702₃, . . . , 702ₙ, as depicted in FIG. 7 and described with respect the FIG. 8.

The trunk cable 708 comprises a plurality of conductors (e.g., wires) interconnecting the plurality of junction boxes 704₁, 704₂, 704₃, . . . , 704ₙ. Each junction box 704 is configured to electrically couple a drop cable 700 (and hence its corresponding SCMI 104, which also may be referred to as a micro-inverter) to the trunk cable 708. In some alternative embodiments, the drop cable 700 may be a cable from a micro-inverter 104 that is spliced at the junction box 704 to the trunk cable 708; or, as described below with respect to FIG. 8, a drop connector 702 may be built into the junction box 704 and the drop cable 700 plugs into the connector 702.

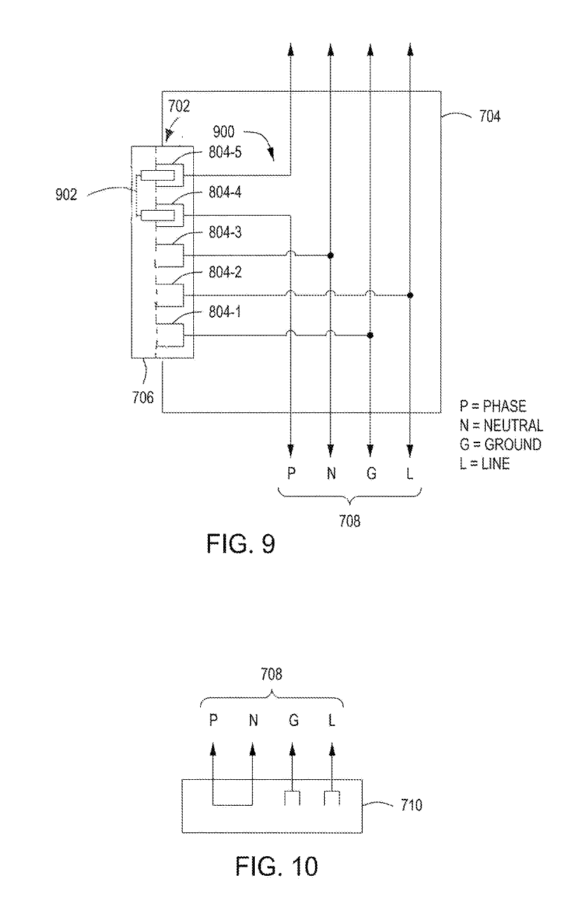

In one embodiment, the junction boxes 704 are spaced along the trunk cable 708 to align with solar panels when the panels are vertically oriented (e.g., approximately spaced by 3 m). If the solar panels are horizontally oriented, then every other junction box 704 is not attached to a micro-inverter 104 (e.g., junction box 704₄). In such embodiments, a special cap 706 is used to terminate the junction box 704. One embodiment of such a cap 706 is described with reference to FIG. 9, below. The trunk cable 708 is terminated at the distal end (away from the AC grid 128) by an end cap 710. One embodiment of an end cap 710 is described with reference to FIG. 10 below.

FIG. 8 depicts a schematic diagram of one embodiment of a junction box 704 of FIG. 7. In the depicted embodiment, the junction box 704 contains a drop cable receptacle 800 as part of the junction box 704 for mating with a drop cable 700 in order to electrically couple a micro-inverter (i.e., a SCMI) to the trunk cable 708. In other embodiments (not shown), a drop cable 700 can be spliced to the trunk cable 708 (at the junction box 704) and a connector positioned at a distal end of the drop cable 700 for coupling to a micro-inverter (or the drop cable 700 may be hardwired to the micro-inverter).

In the exemplary embodiment, the trunk cable 708 has four conductors—line (L), neutral (N), ground (G) and phase (P). The connector 702 has five conductive connector elements—one each for line, neutral, ground, and two for phase. In some embodiments, such as the embodiment depicted in FIG. 8, the drop cable receptacle 800 comprises receptacles 804-1, 804-2, 804-3, 804-4 and 804-5 (collectively referred to as receptacles 804), where each receptacle 804-1, 804-2, 804-3, 804-4 and 804-5 can mate with a plug 802-1, 802-2, 802-3, 802-4 and 802-5, respectively, that terminates a corresponding conductive line 806-1, 806-2, 806-3, 806-4 and 806-5 of the drop cable 700 to electrically couple a micro-inverter (i.e., a SCMI) to the trunk cable 708. In other embodiments, the drop cable receptacle 800 comprises the plugs 802-1, 802-2, 802-3, 802-4 and 802-5 collectively referred to as plugs 802) for mating to receptacles 804-1, 804-2, 804-3, 804-4 and 804-5, respectively, that each terminate a corresponding conductive line 806-1, 806-2, 806-3, 806-4 and 806-5 of the drop cable 700 to electrically couple a micro-inverter (i.e., a SCMI) to the trunk cable 708.

The receptacles 804 that correspond to line, neutral and ground connections (e.g., receptacles 804-1, 804-3, and 804-1 as depicted in FIG. 8) are spliced to substantially continuous conductors within the trunk cable 708, e.g., an unbroken wire, a spliced wire, welded wire, or the like. As such, the line, neutral and ground conductors are conductively continuous. The phase conductor of the trunk cable 708 is serially coupled to the micro-inverter via the junction box 704; i.e., the phase conductor P within the trunk cable 708 is broken (i.e., discontinuous) within the junction box 704 to form an input line and an output line, which are coupled to corresponding receptacles 804 (e.g., receptacles 804-4 and 804-5) of the connector 702. Thus, the micro-inverter applies the generated power across the input and output lines of the phase conductor P. The ground conductor G is optionally coupled to the earth ground of the micro-inverter. The line and neutral conductors (L and N, respectively) are used to provide power to the micro-inverter's electronics and, optionally, communications signals to/from the micro-inverter. In one embodiment, power line communications (PLC) techniques can be used to communicate amongst the micro-inverters (i.e., the SCMIs) and the global controller 126. In this embodiment, the trunk cable 708 encompasses both the AC bus and the control bus. In addition, the line conductor may be coupled to the AC grid 128 to provide a phase reference to the micro-inverters. In some embodiments, the line and neutral conductors are coupled to the AC grid 128 and provide a means for evaluating the grid voltage for synchronizing all of the micro-inverters (via grid synchronization module 608) so that all of the micro-inverters work together and share the grid voltage, as well as a means for evaluating the grid voltage for operating voltage and frequency checks so that the units comply with safety standards.

The ground conductor G in the trunk cable 708 is optional; for example, in some installations, a ground wire may not be necessary. In other installations the line conductor L may also be unnecessary; as such, the SCMIs each unilaterally, locally perform synchronization and the protective functions (e.g., over-voltage and frequency monitoring, anti-islanding, and so on) will be performed by the global controller 126.

The trunk cable 708 may be coupled to the grid 128 by coupling (e.g., splicing) both the trunk cable phase and line conductors P and L to an AC line connection 812 at an AC junction box 810, and coupling (e.g., splicing) the trunk cable neutral and ground conductors N and G to the neutral and ground connections 814 and 816, respectively, at the AC junction box 810. The AC line connection 812, neutral connection 814, and ground connection 816 may then be coupled to the AC grid 128 via a load center.

Another embodiment of the invention uses a plurality of phases (e.g., two phases, three phases) in the trunk cable 708, where a different phase wire of the trunk cable 708 is coupled to different drops. Thus, in a k-phase example, the trunk cable 708 will have conductors P1, P2, P3 . . . Pk, and L1, L2, L3 . . . Lk. Each connector 702 in such a system is the same as previously described, however a different set of phase and line conductors (i.e., a different Pk, Lk set) is used at each drop location. For example, a first SCMI is coupled to phase and line conductors P1/L1, a second SCMI is coupled to phase and line conductors P2/L2, and so on. Is such a system, the phase conductor and line conductor coupled to the drop cable receptacle 800 may be “rotated” at each junction box 704. For example, in a three-phase system, trunk cable conductors P1 and L1 are coupled to the phase and line receptacles of a drop cable receptacle 800-1 at junction box 704-1; trunk cable conductors P2 and L2 are coupled to the phase and line receptacles of a drop cable receptacle 800-2 at junction box 704-2; and trunk cable conductors P3 and L3 are coupled to the phase and line receptacles of a drop cable receptacle 800-3 at junction box 704-3. Generally, within a string 130 the number of SCMIs is divisible by k such that each string 130 creates an equal voltage on each phase. The advantage of having a plurality of phases is that the neutral current is minimized (to the imbalance current), thereby greatly reducing wire losses. In yet another embodiment, the neutral wire is entirely removed for multiphase installations, and all the returns (Pks) are coupled together at the end cap.

In some alternative embodiments where the SCMIs each generate two or three phases of power, the trunk cable 708, drop cables 700, connectors 702, and junction boxes 704 each comprise a suitable number of conductors, receptacles and/or plugs for serially connecting the SCMIs substantially as previously described to produce a two-phase (e.g., split-phase) or three-phase output from the SCMI system 100.

FIG. 9 depicts a schematic diagram of a cap 706 in accordance with one embodiment of the invention. The cap 706 terminates the junction box connector conductors 900 such that the phase conductor input and output lines are shorted to one another via a conductor 902 (e.g., the conductor 902 mates with receptacles 804-4 and 804-5 to couple the phase input and output lines to one another) and the other conductors are an open circuit (e.g., receptacles 804-1, 804-2, and 804-3 are each unmated). If a particular load impedance is needed for any of the trunk cable conductors, the cap 706 may include a load circuit or circuits connected to any of the appropriate trunk cable conductors via the corresponding receptacles 804.

FIG. 10 depicts a schematic view of one embodiment of an end cap 710 for terminating the trunk cable 708. At the distal end of the trunk cable 708 (i.e., the end away from the AC grid connection), the trunk cable 708 is terminated with an end cap 710. End cap 710 couples the trunk cable neutral conductor to the trunk cable phase conductor. The line and ground conductors of the trunk cable 708 are left as open circuits. In one embodiment, the end cap 710 is built into the end junction box 704 (e.g., junction box 704-1 of FIG. 7).

While the foregoing is directed to embodiments of the present invention, other and further embodiments of the invention may be devised without departing from the basic scope thereof, and the scope thereof is determined by the claims that follow.

1. An apparatus for serially coupling a plurality of inverters, comprising:
a cable assembly for (i) coupling the plurality of inverters in series to form a string, and (ii) coupling AC power generated by the plurality of inverters to an AC grid, wherein the cable assembly comprises:
a trunk cable comprising at least one phase conductor and a neutral conductor, wherein the neutral conductor is conductively continuous throughout the trunk cable; and
a plurality of junction boxes, positioned at locations along the trunk cable, for coupling the plurality of inverters to the trunk cable, wherein at each junction box of the plurality of junction boxes the at least one phase conductor is discontinuous for being coupled to a corresponding inverter of the plurality of inverters.

2. The apparatus of claim 1, wherein the plurality of inverters is coupled in parallel to the neutral conductor.

3. The apparatus of claim 2, wherein the trunk cable further comprises a line conductor that is conductively continuous throughout the trunk cable, and wherein the plurality of inverters is coupled in parallel to the line conductor.

4. The apparatus of claim 2, wherein the cable assembly further comprises:
a plurality of drop cables for coupling the plurality of inverters to the plurality of junction boxes in a one-to-one correspondence, wherein each drop cable comprises first and second conductive lines for coupling power from the corresponding inverter across a discontinuous portion of the at least one conductor.

5. The apparatus of claim 3, wherein the at least one phase conductor and the line conductor are coupled to a same AC phase line of the AC grid.

6. The apparatus of claim 3, wherein the line conductor couples communication signals with the plurality of inverters.

7. The apparatus of claim 2, wherein the trunk cable couples a single-phase AC power to the power grid.

8. The apparatus of claim 2, wherein the trunk cable couples a multi-phase AC power to the power grid.

9. The apparatus of claim 8, wherein a first set of junction boxes in the plurality of junction boxes couples single-phase AC power from corresponding inverters to a first AC phase line of the AC grid, and wherein a second set of junction boxes in the plurality of junction boxes couples single-phase AC power from corresponding inverters to a second AC phase line of the AC grid.

10. A serially connected micro-inverter (SCMI) system with trunk and drop cabling, comprising:
a plurality of inverters for converting DC power into AC power;
a cable assembly for (i) coupling the plurality of inverters in series to form a string, and (ii) coupling AC power generated by the plurality of inverters to an AC grid, wherein the cable assembly comprises:
a trunk cable comprising at least one phase conductor and a neutral conductor, wherein the neutral conductor is conductively continuous throughout the trunk cable; and
a plurality of junction boxes, positioned at locations along the trunk cable, for coupling the plurality of inverters to the trunk cable, wherein at each junction box of the plurality of junction boxes the at least one phase conductor is discontinuous for being coupled to a corresponding inverter of the plurality of inverters; and
a controller, coupled to the string, for controlling the plurality of inverters.

11. The SCMI system of claim 10, wherein the plurality of inverters is coupled in parallel to the neutral conductor.

12. The SCMI system of claim 11, wherein the trunk cable further comprises a line conductor that is conductively continuous throughout the trunk cable, and wherein the plurality of inverters is coupled in parallel to the line conductor.

13. The SCMI system of claim 11, wherein the cable assembly further comprises:
a plurality of drop cables for coupling the plurality of inverters to the plurality of junction boxes in a one-to-one correspondence, wherein each drop cable comprises first and second conductive lines for coupling power from the corresponding inverter across a discontinuous portion of the at least one conductor.

14. The SCMI system of claim 12, wherein the at least one phase conductor and the line conductor are coupled to a same AC phase line of the AC grid.

15. The SCMI system of claim 12, wherein the line conductor couples communication signals between the plurality of inverters and the controller.

16. The SCMI system of claim 11, wherein the trunk cable couples a single-phase AC power to the power grid.

17. The SCMI system of claim 11, wherein the trunk cable couples a multi-phase AC power to the power grid.

18. The SCMI system of claim 17, wherein a first set of junction boxes in the plurality of junction boxes couples single-phase AC power from corresponding inverters to a first AC phase line of the AC grid, and wherein a second set of junction boxes in the plurality of junction boxes couples single-phase AC power from corresponding inverters to a second AC phase line of the AC grid.

19. The SCMI system of claim 10, further comprising a plurality of photovoltaic (PV) modules for providing the DC power to the plurality of inverters.

20. The SCMI system of claim 10, wherein the controller synchronizes the plurality of inverters to the AC grid.
